(19) United States
(12) Patent Application Publication
(10) Pub. No.: US 2023/0419367 A1
(43) Pub. Date: Dec. 28, 2023

(54) APPARATUS AND METHOD FOR COMMUNICATING WITH USERS

(71) Applicant: One Call to All Limited, Bolton (GB)

(72) Inventor: Chris Smith, Bolton (GB)

(73) Assignee: One Call to All Limited, Bolton (GB)

(21) Appl. No.: 17/847,923

(22) Filed: Jun. 23, 2022

(51) Int. Cl. G06Q 30/02

(52) U.S. Cl. CPC G06Q 30/0269

(57) ABSTRACT

An apparatus and method for communicating with users includes an automated communication platform connected to a network. Automated communication platform includes an originator and target users. Automated communication platform allows an originator to customize a message and send the message to a set of users, determined by the originator. The users may respond to a custom message using a communication ending. A filter may be used to filter out qualified users.

### FIELD OF THE INVENTION

The present invention generally relates to the field of automated communication. In particular, the present invention is directed to apparatus and method for communicating with users.

### BACKGROUND

Communicating with individuals can be time consuming. However, automating this process is difficult due to the nuances related to customizing communications tailed to individuals.

### SUMMARY OF THE DISCLOSURE

In an aspect an apparatus for communicating with users includes: an automated communication platform communicatively connected to a network, the automated communication platform comprising: an originator device, and at least a user device, and at least a processor communicatively connected to the network, and a memory communicatively connected to the processor, the memory containing instructions configuring the at least a processor to: initiate a communication campaign on the automated communication platform wherein initiating the communication campaign comprises: customizing a message comprising a communication ending, choosing a user device of the at least a user device to receive the communication campaign, and import a set of contact data associated with the chosen user device of the at least a user device, and receive an interaction from the chosen user device of the at least a user device as a result of the communication campaign, wherein the interaction comprises: responding to a filter embedded in the at least a communication ending.

In another aspect a method of communicating with users includes: communicatively connecting an automated communication platform to a network, the automated communication platform comprising: an originator device, and at least a user device, initiating a communication campaign on the automated communication platform wherein initiating the communication campaign comprises: customizing a message comprising a communication ending, choosing a user device of the at least a user device to receive the communication campaign, and import a set of contact data associated with the chosen user device of the at least a user device, and receive an interaction from the chosen user device of the at least a user device as a result of the communication campaign, wherein the interaction comprises: responding to a filter embedded in the at least a communication ending.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an apparatus for communicating with users;

FIG. 2 is an exemplary embodiment of a machine-learning module;

FIG. 3 is an exemplary embodiment of fuzzy set comparison;

FIG. 4 is an exemplary embodiment of a database;

FIG. 5 is a flow diagram illustrating a method of communicating with users; and

FIG. 6 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatus and methods for communicating with users. In an embodiment, an originator may initiate a communication campaign, which is targeted at sending custom messages to at least a user device. Aspects of the current disclosure allow for custom embedded videos and audio messages. A user may respond to a custom communication using user videos and audio messages. Exemplary embodiments illustrating aspects of the present disclosure are described below in the context of several specific examples.

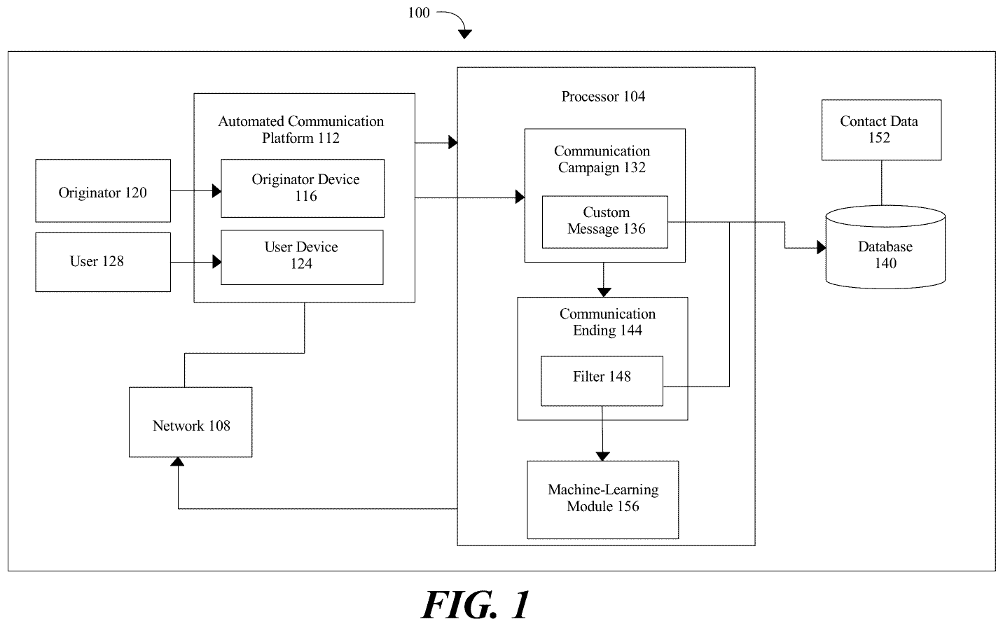

Referring now to FIG. 1, an exemplary embodiment of an apparatus for communicating with users is illustrated. Apparatus 100 includes a processor 104. Processor 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. processor 104 may include but is not limited to, for example, a computing device or cluster of computing devices in a first location and a second computing device or cluster of computing devices in a second location. processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of apparatus 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Continuing to reference FIG. 1, apparatus 100 may include a network 108. Network 108 may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud”, e.g., via the Internet, rather than on local severs or personal computers. A “mesh network” as used in this disclosure is a local network topology in which the processor 104 connect directly, dynamically, and non-hierarchically to as many other computing devices as possible. A “network topology” as used in this disclosure is an arrangement of elements of a communication network. Processor 104 may be communicatively connected to the network 108. An automated communication platform 112 may also be communicatively connected to the network 108.

Continuing to reference FIG. 1, apparatus 100 may include an automated communication platform 112. Processor 104 is configured to connect to automated communication platform 112. The automated communication platform 112 allows the processor to communicate with an originator device 116 and at least a user device 124. As used herein, an “automated communication platform” is an application that allows communications to be sent out in batches as opposed to manually. Communication may include video communication, text communication, audio communication. Automated communication platform 112 may execute communications through SMS, phone call, WhatsApp, and the like. Automated communication platform 112 may also execute communication through website notifications and/or application notifications on a desktop or a mobile device. Automated communication platform 112 includes an originator device 116. As used herein, an “originator device” is a device used to create a communication campaign. A “communication campaign” is an action that is aimed at promoting a product, business, service, or the like, to a target user. An originator device 116 may be operated by an originator 120. An “originator”, as used herein, is a person that is seeking to communicate with the user. Automated communication platform 112 also includes a user device 124, operated by a user 128. The originator device 116 and the user device 124 may be any computing device such as a personal computer, smart phone, tablet, or the like. The originator 120 may be seeking to hire a user 128 for a job opening or, alternatively, communicate with a user 128, and the user 128 may be a prospective candidate seeking employment or open to receiving target communications. Automated communication platform 112 may include a plurality of originator devices and/or user devices. In an embodiment, automated communication platform 112 may include one originator device 116 and at least one user device 124. Originator 120 may use originator device 116 connected to the automated communication platform 112 to send communications to a plurality of user devices.

Continuing to reference FIG. 1, processor 104 is configured to initiate a communication campaign 132 on the automated communication platform 112. Processor 104 may be on originator device 116. An originator utilizing processor 104 may initiate a communication campaign 132. An originator 120 may determine a need to communicate with at least a user device 124. A need may include a need to fill a job opening, marketing outreach such as social media communications, or the like. Initiating a communication campaign 132 may include customizing a message and determined a user device 124 to send the custom message/communication. A “message”, as used herein, is a verbal, written, and/or visual communication for a user.

Continuing to reference FIG. 1, communication campaign 132 includes a custom message 136. Custom message 136 may be inputted by an originator 120. Custom message 136 may include audiovisual data embedded into the communication campaign 132. As used in this disclosure, “audiovisual” relates to information that includes at least visual and auditory content. An originator 120 may record a voice message for a phone, input a text message, embed a video message into a text message, and the like as a custom message 136. The originator 120 may choose at least one communication method, such as a video message or an audio message, or the like, as discussed above. Communication campaign 132 may receive a selection of communication methods that an originator 120 may have chosen. Custom message 136 may be a newly created message and/or a previously used message. Custom message 136 may be a text communication or a video communication, or the like. Custom message 136 may allow a user to record a video. Custom message 136 may be stored in a database 140. Database 140 is discussed in further detail below. Originator 120 may use a custom message 136 previously created and stored in database 140 to communicate with user 128. Additionally, database 140 may include templates for custom messages 136. In an embodiment, an originator 120 may select a message template from a database of templates. For example, an originator 120 looking to recruiter user 128 may use a message template including a job description. The originator 120 may customize a message template by updating the job description to fit the job they are recruiting for. Additionally, template may include greetings to use, introductions, a pitch, or the like. For example, the originator 120 may select a greeting and add it to their custom message 136.

Still referencing FIG. 1, custom message 136 may include a communication ending 144. As used herein, a “communication ending” is a bookend to a message which allows a user to respond to the message. Communication ending 144 may include an automated communication ending, wherein the automated communication platform 112 may automatically add a communication ending 114 to each custom message 136. A user 128 may interact with a communication ending 144/communication campaign 132. Such interactions are discussed below and may include, pressing a button to connect to an originator 120, answering questions in a filter 148, or the like. Communication ending 144 may include a voice bookend to allow a user 128 to connect to the originator 120 immediately. A “voice bookend” is an ending to an audio message. Voice bookend may include a number to dial to connect to the originator 120 immediately. For example, at the end of the audio custom message, a user 128 may be instructed to press “2” to speak to the originator 120. In another embodiment, apparatus 100 may include voice detection such that a user 128 may use voice commands to start a connection with the originator. For example, a user 128 may say “yes” to be connected to an originator 120. In another embodiment, communication ending 114 may include a visual bookend, such as a text or an image. Visual bookend may be an ending to a custom message 136 that also includes instructions to connect to the originator 120, respond to the custom message 136, or the like. The voice bookend and/or visual bookend may be turned on or off by an originator 120. Communication ending 144 may include a link, such as a URL link or the like, in an SMS to allow the user 128 to convey interest in the custom message 136, such as interested in a job opening discussed in the custom message 136. Communication ending 114 may include a link to a filter 148, which may be used to filter users based on qualifications, job requirements, or the like. Filter 148 may include custom tests, questions, qualifications, and the like. Filter 148 is discussed in further detail below. Communication ending 144 may allow a user to send back a multimedia message, such as a video response, pictures, audio, or the like.

Still referencing FIG. 1, initiating the communication campaign 132 includes choosing a user 128 and/or a user device 124. In an embodiment, an originator may import a set of contact data 152 associated with a chosen user 124 and/or user device 124 manually, from a database 140, and/or another platform such as a website. An originator 120 may choose users by importing their set of contact data 152, such as emails, phone numbers, IP addresses, or the like. An originator 120 may import a file, such as a CSV spreadsheet (.xlsx, .xlsm, etc.), containing a set of contact data 152. A file may contain a plurality of contact data associated with a plurality of users. Contact data 152 may be stored in a database, such as database 140 for use in future communication campaigns. In another embodiment, originator 120 may choose a user 128 and their associated set of contact data 152 out of a file to receive a communication campaign 132. For example, if a file contains 10 users and their contact information, an originator may select only 2 of them to receive the communication campaign. In another embodiment, a decision tree may be used to select users to receive a communication campaign 132. A “decision tree” is a flowchart-like structure where each node is a “test” on an attribute. Each user may include a set of attributes that may be filtered through to determine the set of users to receive the communication. For example, the decision tree may include nodes that narrow down the selection of users. The decision tree may be used to narrow down the users to only female users between 19-26. For example, the first node of the decision tree may look at the gender attribute and only select users that are female. The next node of the tree may look at age and only select female users that are between the ages of 19-26.

Still referencing FIG. 1, communication campaign 132 includes filter 148. A “filter”, as used herein, is used to capture data on a user. A filter 148 may capture data on user 128 to determine, in an embodiment, if user 128 is a good fit for a job posting. An originator may create a filter 148 by creating questions, surveys, quizzes, or the like to go along with the custom message 136. Alternatively or additionally, a machine-learning module 156 may be used to create a custom filter 148 based on the communication campaign 132. A first machine-learning model of the machine-learning module 156 may use a classifier to generate filter 148. A “classifier,” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. In an embodiment, processer may use a data classifier. As used in this disclosure, a “data classifier” is an identifying indicia relating to the custom message 136, for example, education level, traits, skills, jobs needed. In an embodiment, processor 104 may classify custom message 136 into categories associated with various jobs, education level, types of certifications, experience related to different degrees, and the like. A classifier may be configured to output at least a datum that labels or otherwise identifies a set of data that are clustered together, found to be close under a distance metric as described below, or the like. Processor 104 and/or another device may generate a classifier using a classification algorithm, defined as a process whereby a processor 104 derives a classifier from training data. In an embodiment, training data may be made up of a plurality of training examples that each include examples of data to be inputted into the machine-learning module 156, such as experience associated with a job, etc., and examples of data to be output therefrom, such as data sets that include questions related to a job description and/or custom message. In some embodiments, training data may also include data that has already been labeled, i.e. data that has already been sorted into categories. Training data may be implemented in any manner discussed below. Training data may be obtained from and/or in the form of previous data set categorization, such that previous iterations may become training data. An originator 120 may provide feedback to machine learning module 156 such that machine learning module 156 may determine more robust classifications and filters with increased use by an originator 120. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 1, processor 104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Processor 104 may then calculate a likelihood table by calculating probabilities of different data entries and classification labels. Processor 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 1, processor 104 may be configured to generate classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent

Continuing to reference FIG. 1, after a user 128 responds to filter 148, a second machine-learning model may classify user 128 into categories associated with jobs, education level, types of certifications, experience related to different degrees, interests and the like based on responses to filter 148. Second machine-learning model may be trained using training data that that includes sample responses to various filters and the associated categories those responses belong in. In an embodiment, filter 148 may be used to determine how qualified a user is for the job listing discussed in custom message 136. For example, if the custom message 136 is reaching out to users for a role in mechanical engineering, a filter 148 may be a questionnaire that includes questions about a user's background. If the user's background does not include a degree in engineering, machine-learning module 156 may group the user into a group that does not qualify for the listed job role. In another example, custom message 136 may include a communication ending 144 with a filter 148 that includes questions about a user's interest. If a user does not state that they are interested in the adoption of dogs, the user 128 may be classified into a group of people not interested in dogs. In the future, communication campaigns relating to dogs may not be sent to this user 128 and/or user device 124.

In an embodiment, a filter 148 may be a questionnaire/test. For example, if the custom message 136 is looking for a user 128 to deliver complex healthcare, there may be a questionnaire with questions that get increasingly harder with each right answer. In an embodiment, the filter 148 may include a decision tree with multiple “nodes”. Based on the response to a question, the filter 148 may ask additional questions that are harder, the same level, or easier than the previous question.

Continuing to reference FIG. 1, a user's response to filter 148 may be in the form of visuals, audio, or text. Audio may be transcribed into text. In some embodiments, processor 104 may transcribe much or even substantially all verbal content from audiovisual data, such as a video or a voice memo, or the like. Processor 104 may transcribe verbal content by way of speech to text or speech recognition technologies. Exemplary automatic speech recognition technologies include, without limitation, dynamic time warping (DTW)-based speech recognition, end-to-end automatic speech recognition, hidden Markov models, neural networks, including deep feedforward and recurrent neural networks, and the like. Generally, automatic speech recognition may include any machine-learning process described in this disclosure.

Still referring to FIG. 1, in some embodiments, an automatic speech recognition process may perform voice recognition or speaker identification. As used in this disclosure, “voice recognition” refers to identifying a speaker, from a response to filter 148, rather than what the speaker is saying. In some cases, processor 104 may first recognize a speaker and then automatically recognize speech of the speaker, for example by way of a speaker dependent automatic speech recognition model or process. In some embodiments, an automatic speech recognition process can be used to authenticate or verify an identity of a speaker.

Still referring to FIG. 1, in some embodiments, an automatic speech recognition process may include one or all of acoustic modeling, language modeling, and statistically-based speech recognition algorithms. In some cases, an automatic speech recognition process may employ hidden Markov models (HMMs). As discussed in greater detail below, language modeling such as that employed in natural language processing applications like document classification or statistical machine translation, may also be employed by an automatic speech recognition process.

Still referring to FIG. 1, an exemplary algorithm employed in automatic speech recognition may include or even be based upon hidden Markov models. Hidden Markov models (HMMs) may include statistical models that output a sequence of symbols or quantities. HMMs can be used in speech recognition because a speech signal can be viewed as a piecewise stationary signal or a short-time stationary signal. For example, over a short time scale (e.g., 10 milliseconds), speech can be approximated as a stationary process. Speech (i.e., audible verbal content) can be understood as a Markov model for many stochastic purposes.

Still referring to FIG. 1, in some embodiments HMMs can be trained automatically and may be relatively simple and computationally feasible to use. In an exemplary automatic speech recognition process, a hidden Markov model may output a sequence of n-dimensional real-valued vectors (with n being a small integer, such as 10), at a rate of about one vector every 10 milliseconds. Vectors may consist of cepstral coefficients. A cepstral coefficient requires using a spectral domain. Cepstral coefficients may be obtained by taking a Fourier transform of a short time window of speech yielding a spectrum, decorrelating the spectrum using a cosine transform, and taking first (i.e., most significant) coefficients. In some cases, an HMM may have in each state a statistical distribution that is a mixture of diagonal covariance Gaussians, yielding a likelihood for each observed vector. In some cases, each word, or phoneme, may have a different output distribution; an HMM for a sequence of words or phonemes may be made by concatenating an HMMs for separate words and phonemes.

Still referring to FIG. 1, in some embodiments, an automatic speech recognition process may use various combinations of a number of techniques in order to improve results. In some cases, a large-vocabulary automatic speech recognition process may include context dependency for phonemes. For example, in some cases, phonemes with different left and right context may have different realizations as HMM states. In some cases, an automatic speech recognition process may use cepstral normalization to normalize for different speakers and recording conditions. In some cases, an automatic speech recognition process may use vocal tract length normalization (VTLN) for male-female normalization and maximum likelihood linear regression (MLLR) for more general speaker adaptation. In some cases, an automatic speech recognition process may determine so-called delta and delta-delta coefficients to capture speech dynamics and might use heteroscedastic linear discriminant analysis (HLDA). In some cases, an automatic speech recognition process may use splicing and a linear discriminate analysis (LDA)-based projection, which may include heteroscedastic linear discriminant analysis or a global semi-tied covariance transform (also known as maximum likelihood linear transform [MLLT]). In some cases, an automatic speech recognition process may use discriminative training techniques, which may dispense with a purely statistical approach to HMM parameter estimation and instead optimize some classification-related measure of training data; examples may include maximum mutual information (MMI), minimum classification error (MCE), and minimum phone error (MPE).

Still referring to FIG. 1, in some embodiments, an automatic speech recognition process may be said to decode speech (i.e., audible verbal content). Decoding of speech may occur when an automatic speech recognition system is presented with a new utterance and must compute a most likely sentence. In some cases, speech decoding may include a Viterbi algorithm. A Viterbi algorithm may include a dynamic programming algorithm for obtaining a maximum a posteriori probability estimate of a most likely sequence of hidden states (i.e., Viterbi path) that results in a sequence of observed events. Viterbi algorithms may be employed in context of Markov information sources and hidden Markov models. A Viterbi algorithm may be used to find a best path, for example using a dynamically created combination hidden Markov model, having both acoustic and language model information, using a statically created combination hidden Markov model (e.g., finite state transducer [FST] approach).

Still referring to FIG. 1, in some embodiments, speech (i.e., audible verbal content) decoding may include considering a set of good candidates and not only a best candidate, when presented with a new utterance. In some cases, a better scoring function (i.e., re-scoring) may be used to rate each of a set of good candidates, allowing selection of a best candidate according to this refined score. In some cases, a set of candidates can be kept either as a list (i.e., N-best list approach) or as a subset of models (i.e., a lattice). In some cases, re-scoring may be performed by optimizing Bayes risk (or an approximation thereof). In some cases, re-scoring may include optimizing for sentence (including keywords) that minimizes an expectancy of a given loss function with regards to all possible transcriptions. For example, re-scoring may allow selection of a sentence that minimizes an average distance to other possible sentences weighted by their estimated probability. In some cases, an employed loss function may include Levenshtein distance, although different distance calculations may be performed, for instance for specific tasks. In some cases, a set of candidates may be pruned to maintain tractability.

Still referring to FIG. 1, in some embodiments, an automatic speech recognition process may employ dynamic time warping (DTW)-based approaches. Dynamic time warping may include algorithms for measuring similarity between two sequences, which may vary in time or speed. For instance, similarities in walking patterns would be detected, even if in one video the person was walking slowly and if in another he or she were walking more quickly, or even if there were accelerations and deceleration during the course of one observation. DTW has been applied to video, audio, and graphics—indeed, any data that can be turned into a linear representation can be analyzed with DTW. In some cases, DTW may be used by an automatic speech recognition process to cope with different speaking (i.e., audible verbal content) speeds. In some cases, DTW may allow processor 104 to find an optimal match between two given sequences (e.g., time series) with certain restrictions. That is, in some cases, sequences can be “warped” non-linearly to match each other. In some cases, a DTW-based sequence alignment method may be used in context of hidden Markov models.

Still referring to FIG. 1, in some embodiments, an automatic speech recognition process may include a neural network. In some cases, neural networks may be used for automatic speech recognition, including phoneme classification, phoneme classification through multi-objective evolutionary algorithms, isolated word recognition, audiovisual speech recognition, audiovisual speaker recognition and speaker adaptation. In some cases, neural networks employed in automatic speech recognition may make fewer explicit assumptions about feature statistical properties than HMMs and therefore may have several qualities making them attractive recognition models for speech recognition. When used to estimate the probabilities of a speech feature segment, neural networks may allow discriminative training in a natural and efficient manner. In some cases, neural networks may be used to effectively classify audible verbal content over short-time interval, for instance such as individual phonemes and isolated words. In some embodiments, a neural network may be employed by automatic speech recognition processes for pre-processing, feature transformation and/or dimensionality reduction, for example prior to HMM-based recognition. In some embodiments, long short-term memory (LSTM) and related recurrent neural networks (RNNs) and Time Delay Neural Networks (TDNN's) may be used for automatic speech recognition, for example over longer time intervals for continuous speech recognition.

With continued reference to FIG. 1, processor 104 may recognize verbal content not only from speech (i.e., audible verbal content). For example, in some cases, audible verbal content recognition may be aided in analysis of an image. For instance, in some cases, processor 104 may use an image to aid in recognition of audible verbal content as a viewing a speaker (e.g., lips) as they speak aids in comprehension of his or her speech. In some cases, processor 104 may include audiovisual speech recognition processes.

Still referring to FIG. 1, in some embodiments, audio visual speech recognition (AVSR) may include techniques employing image processing capabilities in lip reading to aid speech recognition processes. In some cases, AVSR may be used to decode (i.e., recognize) indeterministic phonemes or help in forming a preponderance among probabilistic candidates. In some cases, AVSR may include an audio-based automatic speech recognition process and an image-based automatic speech recognition process. AVSR may combine results from both processes with feature fusion. Audio-based speech recognition process may analysis audio according to any method described herein, for instance using a Mel-frequency cepstrum coefficients (MFCCs) and/or log-Mel spectrogram derived from raw audio samples. Image-based speech recognition may perform feature recognition to yield an image vector. In some cases, feature recognition may include any feature recognition process described in this disclosure, for example a variant of a convolutional neural network. In some cases, AVSR employs both an audio datum and an image datum to recognize verbal content. For instance, audio vector and image vector may each be concatenated and used to predict speech made by a user, who is ‘on camera.’

With continued reference to FIG. 1, in some embodiments, optical character recognition may be used to parse a response to filter 148. In some cases, a response to filter 148 may be in the form of written or visual verbal content.

Still referring to FIG. 1, in some embodiments, optical character recognition or optical character reader (OCR) includes automatic conversion of images of written (e.g., typed, handwritten or printed text) into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine-learning processes. In some cases, intelligent word recognition (IWR) may recognize written text, one word at a time, for instance by employing machine-learning processes.

Still referring to FIG. 1, in some cases OCR may be an “offline” process, which analyses a static document or image frame. In some cases, handwriting movement analysis can be used as input to handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of the response. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to image component 112 to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from a background of image component. In some cases, binarization may be required for example if an employed OCR algorithm only works on binary images. In some cases. a line removal process may include removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms.

Still referring to FIG. 1, in some embodiments an OCR process will include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of the user data 108. Matrix matching may also rely on a stored glyph being in a similar font and at a same scale as input glyph. Matrix matching may work best with typewritten text.

Still referring to FIG. 1, in some embodiments, an OCR process may include a feature extraction process. As used in this disclosure, a “feature” is an individual measurable property or characteristic. In some cases, feature extraction may decompose a glyph into at least a feature. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning process 116 like nearest neighbor classifiers (e.g., k-nearest neighbors algorithm) can be used to compare image features with stored glyph features and choose a nearest match. OCR may employ any machine-learning process described in this disclosure. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

Still referring to FIG. 1, in some cases, OCR may employ a two-pass approach to character recognition. Second pass may include adaptive recognition and use letter shapes recognized with high confidence on a first pass to recognize better remaining letters on the second pass. In some cases, two-pass approach may be advantageous for unusual fonts or low-quality images where visual verbal/written content may be distorted. Another exemplary OCR software tool include OCRopus. OCRopus development is led by German Research Centre for Artificial Intelligence in Kaiserslautern, Germany. In some cases, OCR software may employ neural networks.

Still referring to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

Continuing to reference FIG. 1, processor 104 is configured to parse a response to a filter 148, using the methods discussed above, for a keyword. As used in this disclosure, a “keyword” is an element of word or syntax used to identify and/or match elements to each other. For example, a keyword may include “Certified Public Accounting” to match a response to a filter 148 to a custom message 136, such as a job listing. In an embodiment, the closer the response to a filter 148 is to keywords relating to the custom message, the more likely the response would be matched. A keyword may be found using a machine-learning process. Processor 104 may employ any machine-learning process as discussed herein. Machine-learning process may be trained using training data to classify a response to a filter 148 to a keyword. Training data may include existing keyword-response pairs, a database of potential keywords, and the like. Machine-learning process may use classifiers to group responses to a keyword. In some cases, machine-learning process may be iterative such that the outputted keyword-response pairs may be used as future training data for the machine-learning process.

Still referencing FIG. 1, filter 148 and a user's response to filter 148 may be stored in a database, such as database 140. In an embodiment, originator 120 may access custom created filters associated with a custom message 136, and a user's response to filter 148 through a database, such as database 140. Qualified users and/or relevant users (to a marketing campaign) may be shown through the use of machine-learning module 156. The second machine-learning model may categorize users into a qualified or non-qualified group, as mentioned above. Alternatively, originator 120 may manually select qualified users and/or relevant users from database 140.

Continuing to reference FIG. 1, apparatus 100 may be implemented in a metaverse. As used herein, a “metaverse” is a virtual reality space where users may interact with other users in a computer-generated environment. In an embodiment, user 128 may receive a communication campaign 132 in the form of an “avatar”. An “avatar”, as used herein, is a digital representative. The user 128 may be an avatar receiving a communication campaign 132 from another avatar. In an embodiment, user 128 may receive a notification of a communication campaign 132, while not active in the metaverse. User 128 may receive a notification through a personal device such as devices as discussed herein. Additionally, or alternatively, user 128 may be able to “pass” the communication campaign 132 to other users in the metaverse, or in real life. For example, user 128 may be able to forward a communication campaign 132 through a text, email, or the like. In the metaverse, user 128 may be able to send the communication campaign avatar to another user in the metaverse.

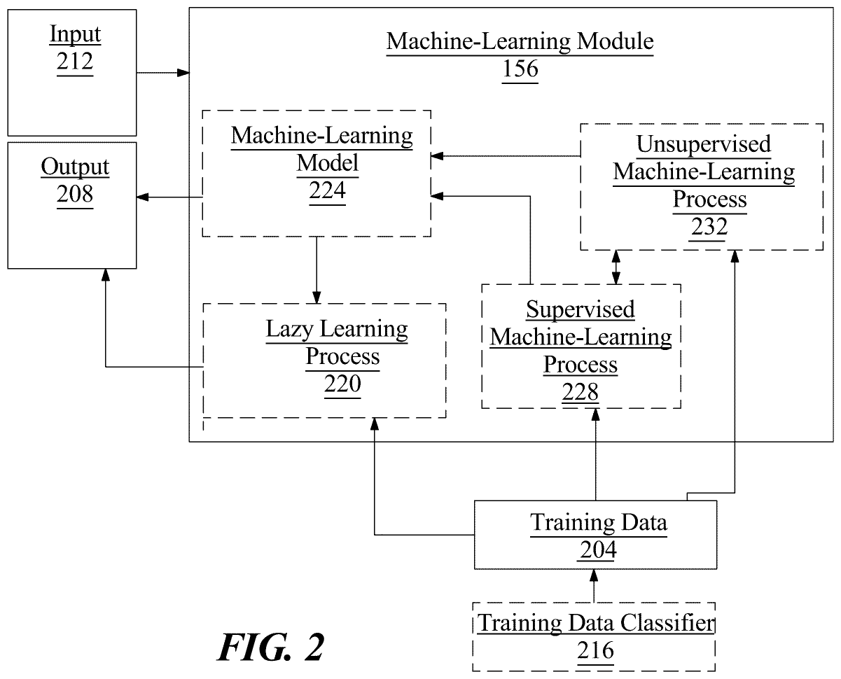

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example, training data may correlate input data, such as type of custom message, target audience of custom message, and the like, with outputs such as quizzes related to the custom message such as questions related to a job that is discussed in custom message, and the like. Additionally, training data 204 may be updated, such machine-learning module 156 may be refined with increased used by a user. In an embodiment, each set of input data and output data may be added to training data 204 such that each use of machine-learning module 156 includes an updated training data set. This way, machine-learning module 156 may be refined with use.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs and outputs as described above in this disclosure, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

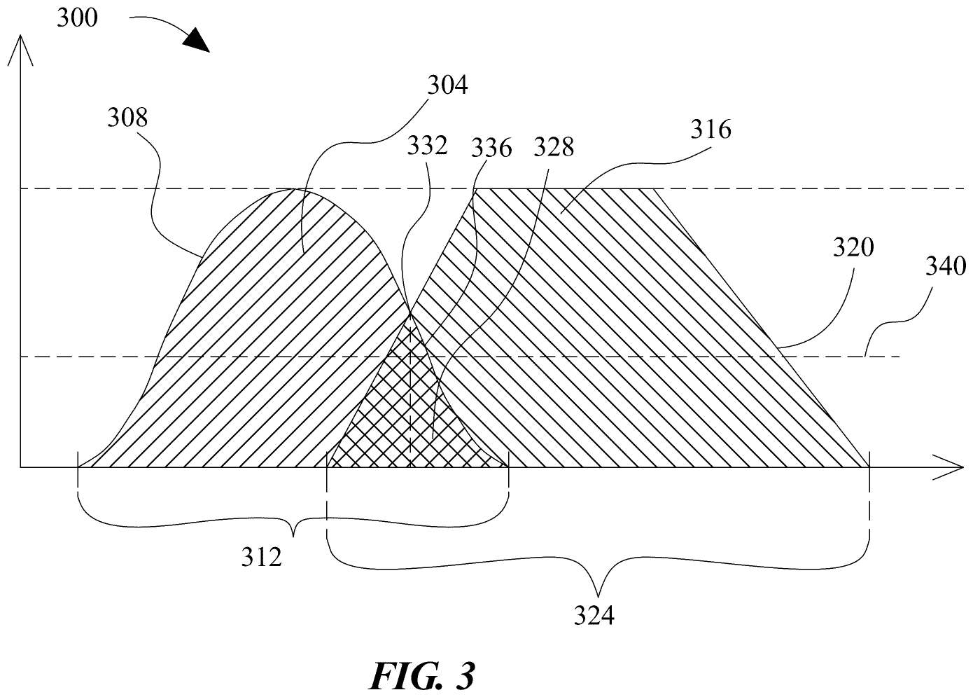

Referring to FIG. 3, an exemplary embodiment of fuzzy set comparison 300 is illustrated. A first fuzzy set 304 may be represented, without limitation, according to a first membership function 308 representing a probability that an input falling on a first range of values 312 is a member of the first fuzzy set 304, where the first membership function 308 has values on a range of probabilities such as without limitation the interval [0,1], and an area beneath the first membership function 308 may represent a set of values within first fuzzy set 304. Although first range of values 312 is illustrated for clarity in this exemplary depiction as a range on a single number line or axis, first range of values 312 may be defined on two or more dimensions, representing, for instance, a Cartesian product between a plurality of ranges, curves, axes, spaces, dimensions, or the like. First membership function 308 may include any suitable function mapping first range 312 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 3, first fuzzy set 304 may represent any value or combination of values as described above, including output from one or more machine-learning models. A second fuzzy set 316, which may represent any value which may be represented by first fuzzy set 304, may be defined by a second membership function 320 on a second range 324; second range 324 may be identical and/or overlap with first range 312 and/or may be combined with first range via Cartesian product or the like to generate a mapping permitting evaluation overlap of first fuzzy set 304 and second fuzzy set 316. Where first fuzzy set 304 and second fuzzy set 316 have a region 328 that overlaps, first membership function 308 and second membership function 320 may intersect at a point 332 representing a probability, as defined on probability interval, of a match between first fuzzy set 304 and second fuzzy set 316. Alternatively or additionally, a single value of first and/or second fuzzy set may be located at a locus 336 on first range 312 and/or second range 324, where a probability of membership may be taken by evaluation of first membership function 308 and/or second membership function 320 at that range point. A probability at 328 and/or 332 may be compared to a threshold 340 to determine whether a positive match is indicated. Threshold 340 may, in a non-limiting example, represent a degree of match between first fuzzy set 304 and second fuzzy set 316, and/or single values therein with each other or with either set, which is sufficient for purposes of the matching process; for instance, threshold may indicate a sufficient degree of overlap between an output from one or more machine-learning models and/or user response data, for combination to occur as described above. Alternatively or additionally, each threshold may be tuned by a machine-learning and/or statistical process, for instance and without limitation as described in further detail below.

Further referring to FIG. 3, in an embodiment, a degree of match between fuzzy sets may be used to classify a user response to a filter 148 with types of job description. For instance, if a user response has a fuzzy set matching types of job description fuzzy set by having a degree of overlap exceeding a threshold, computing device 104 may classify the user response as belonging to the types of job description. Where multiple fuzzy matches are performed, degrees of match for each respective fuzzy set may be computed and aggregated through, for instance, addition, averaging, or the like, to determine an overall degree of match.

Still referring to FIG. 3, in an embodiment, a user response may be compared to multiple job description fuzzy sets. For instance, a user response may be represented by a fuzzy set that is compared to each of the multiple job fuzzy sets; and a degree of overlap exceeding a threshold between the user response fuzzy set and any of the multiple job fuzzy sets may cause computing device 104 to classify the user response as belonging to a certain category of job description (i.e. engineering, health) and/or a certain level of experience for a job. For instance, in one embodiment there may be two user response fuzzy sets, representing respectively answers to test questions and job descriptions. First user response may have a first fuzzy set; Second user response may have a second fuzzy set; and user response may have a user response fuzzy set. Computing device 104, for example, may compare a user response fuzzy set with each of job description fuzzy set and answers to test questions fuzzy set, as described above, and classify a user response to either, both, or neither of answers to test question or job descriptions. Machine-learning methods as described throughout may, in a non-limiting example, generate coefficients used in fuzzy set equations as described above, such as without limitation x, c, and a of a Gaussian set as described above, as outputs of machine-learning methods. Likewise, user response may be used indirectly to determine a fuzzy set, as user response fuzzy set may be derived from outputs of one or more machine-learning models that take the user response directly or indirectly as inputs.

Still referring to FIG. 3, a computing device may use a logic comparison program, such as, but not limited to, a fuzzy logic model to determine a score. A score may include, but is not limited to, amateur, average, knowledgeable, superior, and the like; each such score may be represented as a value for a linguistic variable representing score, or in other words a fuzzy set as described above that corresponds to a degree of compatibility as calculated using any statistical, machine-learning, or other method that may occur to a person skilled in the art upon reviewing the entirety of this disclosure. In other words, a given element of user response may have a first non-zero value for membership in a first linguistic variable value such as degree of compatibility and a second non-zero value for membership in a second linguistic variable value such as similarity. In some embodiments, determining an user response may include using a linear regression model. A linear regression model may include a machine learning model. A linear regression model may be configured to map data of user responses such as answers to test questions, to one or more scores. A linear regression model may be trained using training data as discussed above. In some embodiments, determining a score of user input may include using an score classification model. An score classification model may be configured to input collected data and cluster data to a centroid based on, but not limited to, frequency of appearance, and the like. Centroids may include scores assigned to them such that each user response may each be assigned a score. In some embodiments, an score classification model may include a K-means clustering model. In some embodiments, an score classification model may include a particle swarm optimization model. In some embodiments, determining a score of user response may user response using a fuzzy inference engine. A fuzzy inference engine may be configured to map one or more data elements using fuzzy logic. In some embodiments, a plurality of entity assessment devices may be arranged by a logic comparison program into score arrangements. An “score arrangement” as used in this disclosure is any grouping of objects and/or data based on skill level and/or output score. This step may be implemented as described above in FIGS. 1-2. Membership function coefficients and/or constants as described above may be tuned according to classification and/or clustering algorithms. For instance, and without limitation, a clustering algorithm may determine a Gaussian or other distribution of questions about a centroid corresponding to a given level, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 3, an inference engine may be implemented according to input and/or output membership functions and/or linguistic variables. Continuing the example, an output linguistic variable may represent, without limitation, a score value. An inference engine may combine rules, such as: “if the difficulty level is ‘hard’ and the popularity level is ‘high’, the question score is ‘high’”—the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max(a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

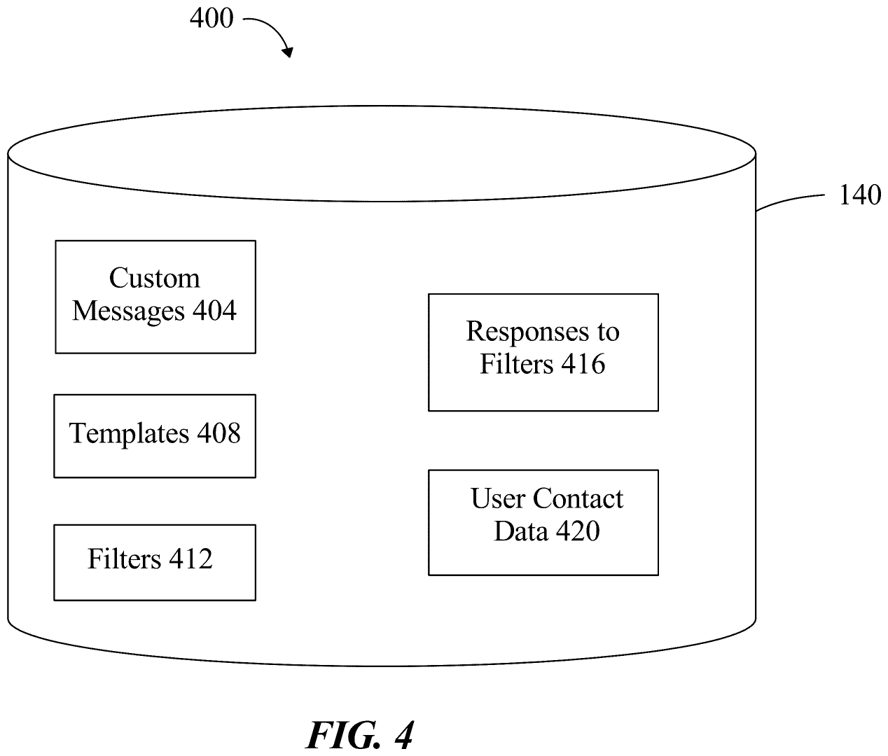

Now referencing FIG. 4, an exemplary embodiment 400 of database 140 is shown. Database 140 may be implemented, without limitation, as a relational database, a key-value retrieval database such as a NOSQL database, or any other format or structure for use as a database that a person skilled in the art would recognize as suitable upon review of the entirety of this disclosure. A key-value retrieval database may include any key such as voice activation. Database 140 may alternatively or additionally be implemented using a distributed data storage protocol and/or data structure, such as a distributed hash table or the like. Database 140 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. Database 140 may be used to store custom messages 404, templates 408 for custom messages, filters 412, responses to filters 416, user contact data 420, and the like. Custom messages 404 may be consistent with any custom messages as discussed above. Templates 408 may be consistent with any template as discussed herein. Filters 412 and response to filters 416 may be consistent with any filter and response as discussed herein. User contact data 420 may be consistent with any user contact data as discussed herein.

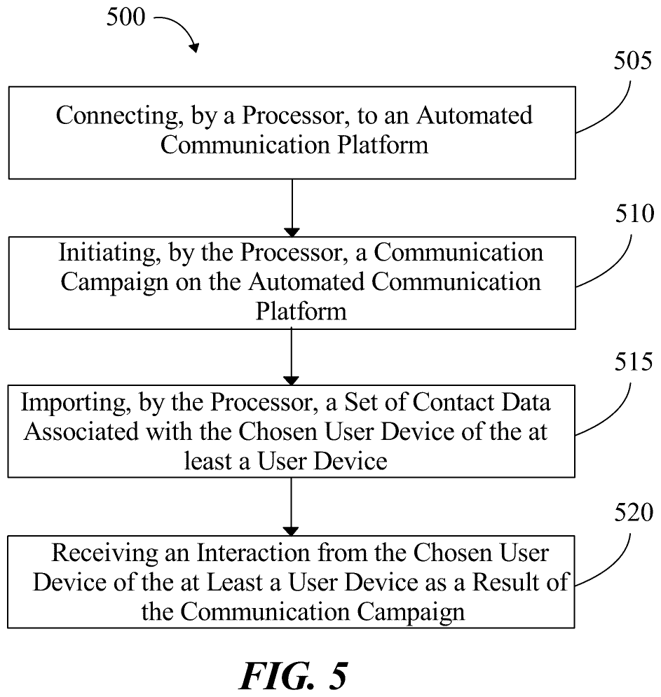

Now referencing to FIG. 5, a method 500 of communicating with users is shown. Step 505 of method 500 includes connecting, by a processor, to an automated communication platform. The automated communication platform includes an originator device and a user device. There may be a plurality of devices on the platform. The automated communication platform may include any receiving device, such as a voice assistant like SIRI, ALEXA, Google Assistant, and the like. This may be implemented as disclosed with reference to FIGS. 1-4 above.

Step 510 of method 500 includes initiating a communication campaign on the automated communication platform. Initiating a communication campaign includes customizing a message, which includes a communication ending. Communication ending may include filters, links, or the like. Communication ending may give a user the ability to respond to a message from the communication campaign. Alternatively, a user may respond to a message before the audio or visual bookend. Filters may allow an originator to learn more about users receiving a custom message. Filter may use a machine-learning module to create customized tests based on the communication campaign. A “test” as used herein, is a written or spoken examination of a person's history, proficiency, and/or knowledge. For example, filter may include a test, testing a user's ability to detect grammar mistakes in sentences for a communication campaign looking for applications for a proofreading job. In another embodiment, filter may include force-balance questions for a communication campaign looking for a civil engineer. In another embodiment, filter may be a questionnaire to gather information on a user's work preferences. Additionally, a user may be classified based on their response to the filter. Initiating a communication campaign further includes choosing a user device to receive a communication campaign. This may include gathering user contact data such as phone numbers, emails, and the like. This may be implemented as disclosed with references to FIGS. 1-4 above.

Step 515 of method 500 includes importing, by the processor, a set of contact data associated with the chosen user device of the at least a user device. Contact data may include a way for a user to receive a message from the communication platform. For example, contact data may include phone numbers, fax numbers, emails, or the like. Contact data may also include user information such as age, sex, vaccination status, or the like. This data may be used by a decision tree, as discussed above, to narrow down the users to send the communication campaign to. This may be implemented as disclosed with reference to FIGS. 1-4 above.

Step 520 of method 500 includes receiving an interaction from the chosen user device of the at least a user device as a result of the communication campaign. An interaction from the chosen device may include a video recording, text message, email, or the like from a user as a response to a custom message. The interaction may be through a voice assistant, such as those as discussed above. In an embodiment, a voice assistant may deliver the custom message and a user may interact with the communication campaign through the voice assistant. A communication ending may have a link, filter, or the like, for the user device to interact with the processor. Users may use a user device to respond to a filter, link, or the like. User may use a user device to submit video recordings, text messages, emails, or the like in response to a custom message. This may be implemented as disclosed with reference to FIGS. 1-4 above.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a home device, a web appliance, a network router, a network switch, a network bridge, any machine capable of executing a sequence of instructions that specify an action to be taken by that machine, and any combinations thereof. In one example, a computing device may include and/or be included in a kiosk.

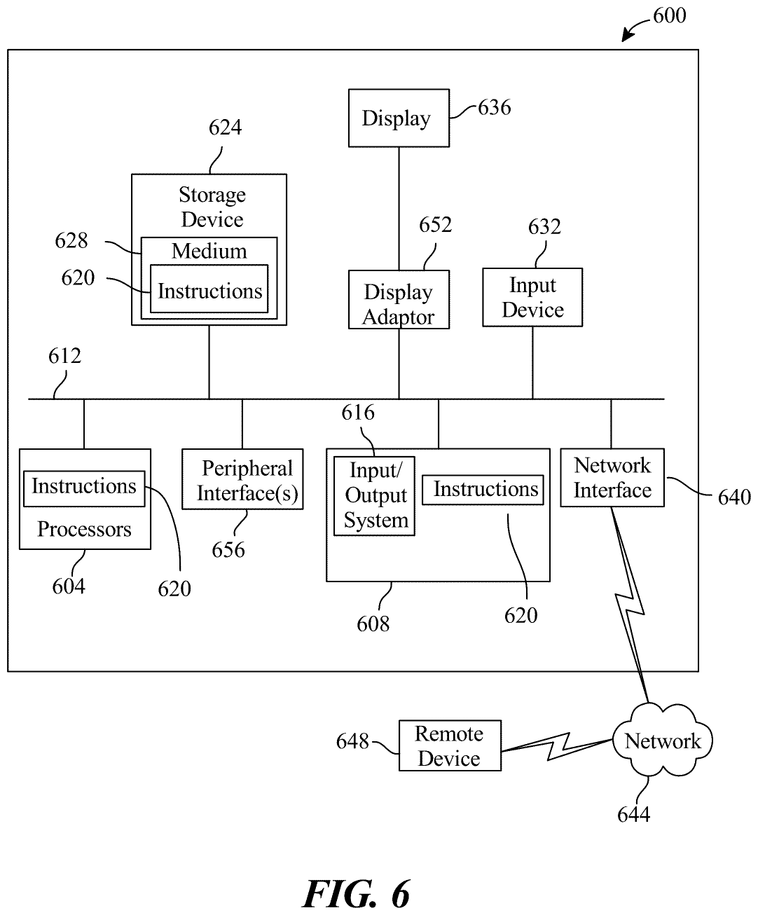

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 632. In one example, a user of computer system 600 may enter commands and/or other information into computer system 600 via input device 632. Examples of an input device 632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer system 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for communicating with users, the apparatus comprising:
at least a processor communicatively connected to a network; and
a memory communicatively connected to the processor, the memory containing instructions configuring the at least a processor to:
connect to an automated communication platform, wherein the automated communication platform allows the processor to communicate with:
an originator device; and
at least a user device each associated with a user of a plurality of users;
initiate a communication campaign on the automated communication platform, wherein initiating the communication campaign comprises:
customizing a message comprising a communication ending; and
choosing a user device of the at least a user device to receive the communication campaign;
receive training data correlating filters and communication campaigns, wherein the training data iteratively trains a machine learning model that outputs custom filters, wherein training the machine learning model comprises:
generating a plurality of first vector outputs, each first vector output containing a training data cluster representing a feature category of a filter;
generating a second vector output containing a custom message; and
calculating a distance between the first vector output and the second vector, wherein the first vector and second vector is normalized in order to make a vector comparison independent of absolute quantities of attributes;
classify, using the machine learning model, a custom message to a custom filter for the communication campaign based on a calculated distance of equivalent similarity of the second vector output to a first vector output of the plurality of first vector outputs;
import a file comprising a set of contact data associated with the chosen user device of the at least a user device; and
receive an interaction from a user associated with the chosen user device of the at least a user device as a result of the communication campaign, wherein the interaction comprises a response to the custom filter embedded in the communication ending and receiving the interaction from the chosen user comprises:
authenticating an identity of the user associated with the chosen user device as a function of a automatic speech recognition process and the interaction; and
parsing the interaction for at least one keyword as a function of audio visual speech recognition comprising an audio-based speech recognition process and an image-based speech recognition process.

2. The apparatus of claim 1, wherein the custom filter includes a customized test.

3. (canceled)

4. The apparatus of claim 2, wherein the memory further contains instructions configuring the at least a processor to classify a user based on a response to the custom filter.

5. The apparatus of claim 1, wherein customizing the message further comprises embedding audiovisual data into the communication campaign.

6. The apparatus of claim 5, wherein the audiovisual data includes a video recording.

7. The apparatus of claim 1, wherein importing the set of contact data comprises importing the set of contact data from a database of contact data.

8. (canceled)

9. The apparatus of claim 1, wherein the communication ending includes a link to allow the user to connect to an originator.

10. The apparatus of claim 1, wherein initiating the communication campaign further comprises receiving a selection of at least one communication preference from an originator.

11. A method of communicating with users, the method comprising:
connecting, by a processor, to an automated communication platform, wherein the automated communication platform allows the processor to communicate with:
an originator device; and
at least a user device each associated with a user of a plurality of users;
initiating, by the processor, a communication campaign on the automated communication platform wherein initiating the communication campaign comprises:
customizing a message comprising a communication ending; and
choosing a user device of the at least a user device to receive the communication campaign;
receiving training data correlating filters and communication campaigns, wherein the training data iteratively trains a machine learning model that outputs custom filters, wherein training the machine learning model comprises:
generating a plurality of first vector outputs, each first vector output containing a training data cluster representing a feature category of a filter;
generating a second vector output containing a custom message; and
calculating a distance between the first vector output and the second vector, wherein the first vector and second vector is normalized in order to make a vector comparison independent of absolute quantities of attributes:
classifying, using the machine learning model, a custom message to a custom filter for the communication campaign based on a calculated distance of equivalent similarity of the second vector output to a first vector output of the plurality of first vector outputs;
importing, by the processor, a file comprising a set of contact data associated with the chosen user device of the at least a user device; and
receiving, by the processor, an interaction from a user associated with the chosen user device of the at least a user device as a result of the communication campaign, wherein the interaction comprises a response to the custom filter embedded in the communication ending and receiving the interaction from the chosen user comprises:
authenticating an identity of the user associated with the chosen user device as a function of at a automatic speech recognition process and the interaction; and
parsing the interaction for at least one keyword as a function of audio visual speech recognition comprising an audio-based speech recognition process and an image-based speech recognition process.

12. The method of claim 11, wherein the custom filter includes a customized test.

13. (canceled)

14. The method of claim 12, further comprising classifying, using the processor, a user based on a response to the custom filter.

15. The method of claim 11, wherein customizing the message further comprises embedding audiovisual data into the communication campaign.

16. The method of claim 15, wherein the audiovisual data includes a video recording.

17. The method of claim 11, wherein importing the set of contact data comprises importing the set of contact data from a database of contact data.

18. (canceled)

19. The method of claim 11, wherein the communication ending includes a link to allow the user to connect to an originator.

20. The method of claim 11, wherein initiating the communication campaign further comprises receiving a selection of at least one communication preference from an originator.
